(19) United States
(12) Patent Application Publication
(10) Pub. No.: US 2009/0210400 A1
(43) Pub. Date: Aug. 20, 2009

(54) Translating Identifier in Request into Data Structure

(75) Inventors: Pablo Martin Castro, Redmond, WA (US); Anders Hejlsberg, Seattle, WA (US); Nikhil Kothari, Sammamish, WA (US); Marcelo Lopez Ruiz, Kirkland, WA (US); Michael Justin Flasko, Duvall, WA (US); Pratik Patel, Bothell, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/032,640

(22) Filed: Feb. 15, 2008

(51) Int. Cl. G06F 17/30

(52) U.S. Cl. 707/4; 707/10; 707/E17.112

(57) ABSTRACT

Aspects of the subject matter described herein relate to translating an identifier in a request into a data structure. In aspects, a client sends a data access request that includes a URI formatted according to the HTTP protocol. The data access request may include a request to create, change, retrieve, or delete one or more resources. The URI is received by a server that has components to translate the URI into a data structure that defines one or more resources indicated by the URI. This data structure is passed to a data source adapter that translates the data structure into operations used to access data on the data source associated with the data source adapter. There may be a plurality of data source adapters with each data source adapter structured to access data on a particular data source using the data structure to define the resources to access.

### BACKGROUND

In traditional Web based applications, a client requests a Web page from a Web server. In response, the Web server renders HTML content corresponding to a Web page and sends the HTML content to the client. The HTML content may include presentation aspects such as fonts, colors, and layout, the data itself, and perhaps some client-side code to drive interaction. When the client needs additional data, it requests a new page from the Web server which then goes through the same process to generate a new page of HTML for the client.

### SUMMARY

Briefly, aspects of the subject matter described herein relate to translating an identifier in a request into a data structure. In aspects, a client sends a data access request that includes a URI formatted according to the HTTP protocol. The data access request may include a request to create, change, retrieve, or delete one or more resources. The URI is received by a server that has components to translate the URI into a data structure that defines one or more resources indicated by the URI. This data structure is passed to a data source adapter that translates the data structure into operations used to access data on the data source associated with the data source adapter. There may be a plurality of data source adapters with each data source adapter structured to access data on a particular data source using the data structure to define the resources to access.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram illustrating the data accessing components of FIG. 2 in accordance with aspects of the subject matter described herein;

FIG. 4 is a block diagram that generally represents exemplary entity types and associations that may be stored in a data source in accordance with aspects of the subject matter described herein; and

FIG. 5 is a flow diagram that generally represents exemplary actions that may occur in accordance with aspects of the subject matter described herein.

### DETAILED DESCRIPTION

### Definitions

In the claims, where a first item, component, data structure, object, module, action, or the like (hereinafter generically referred to as “item”) is followed by “one or more of” followed by a list of items, this is to be interpreted to mean that that the first item may include any one of the items in the list, any combination of the items in the list, a plurality of one of the items in the list, a plurality of any combination of the items in the list, and that the first item may also include other items not in the list as long as the first item includes at least one item in the list. In the claims, in no case is the phrase “one or more of” to represent a close-ended list in which the first item may only include items in the list. Neither is the phrase “one or more of” to indicate that the first item must include only a combination of all of the items in the list.

### Exemplary Operating Environment

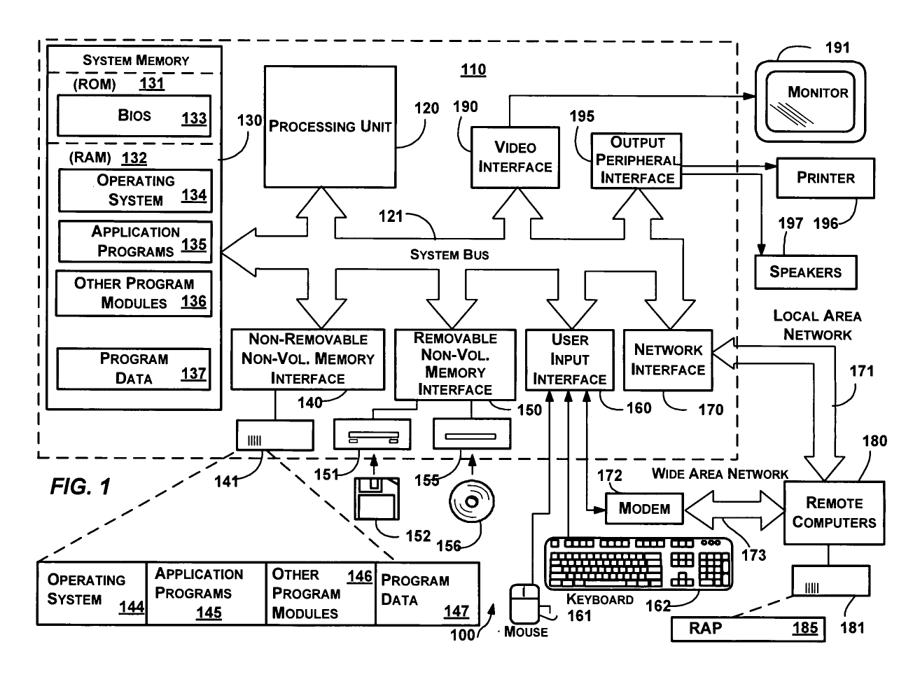

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Generic Queryable Data Sources

As mentioned previously, in traditional Web based applications, a client requests a Web page from a Web server. In response, the Web server renders HTML content corresponding to a Web page and sends the HTML content to the client. To obtain additional data from the Web server, the client requests another Web page from the server. Using this pattern, it is difficult to create a highly-interactive rich application experience for users.

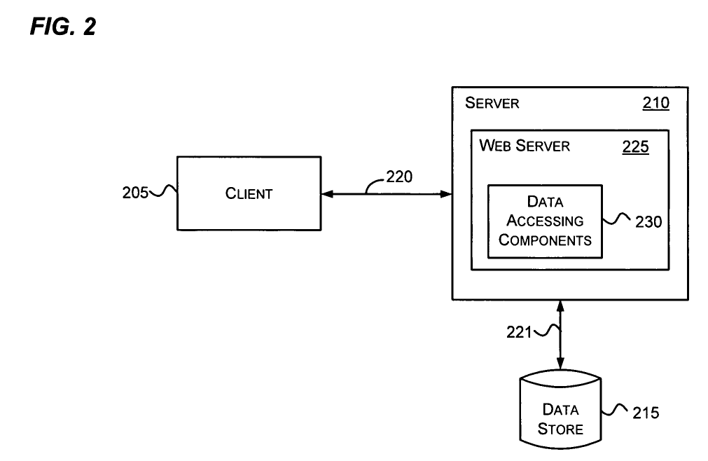

FIG. 2 is a block diagram representing an exemplary environment in which aspects of the subject matter described herein may be implemented. The environment includes a network 220, a client 205, and a server 210. The server 210 may include or be attached to the data store 215. Sometimes the client 205, the server 210, and the data store 215 are referred to as entities. The environment may also include other entities (not shown).

Where a line (e.g., the lines 220-221) connects one entity to another, it is to be understood that the two entities may be connected (e.g., logically, physically, virtual, or otherwise) via any type of network including a direct connection, a local network, a non-local network, the Internet, some combination of the above, and the like.

The client 205 and the server 210 may be implemented on or as one or more computers (e.g., the computer 110 as described in conjunction with FIG. 1). Although the terms “client” and “server” are used, it is to be understood, that a client may be implemented on a machine that has hardware and/or software that is typically associated with a server and that likewise, a server may be implemented on a machine that has hardware and/or software that is typically associated with a desktop, personal, or mobile computer. Furthermore, a client may at times act as a server and vice versa. In an embodiment, the client 205 and the server 210 may both be peers, servers, or clients. In one embodiment, the client 205 and the server 210 may be implemented on the same physical machine.

The store 215 comprises any storage media capable of storing data. The term data is to be read to include information, program code, program state, program data, other data, and the like. The store 215 may comprise a file system, database, volatile memory such as RAM, other storage, some combination of the above, and the like and may be distributed across multiple devices. The store 215 may be external, internal, or include components that are both internal and external to the server 210.

The client 205 may include a process that seeks to access data stored on the data store 215. Access as used herein includes reading data, writing data, deleting data, updating data, a combination including one or more of the above, and the like. Writing data may include updating existing data, adding additional data, and the like.

A process that seeks to access data stored on the data store 215 may, for example, be part of an application, an operating system component, a service, or the like. The term process is to be read to include any mechanism within a computer by which actions are performed.

To access data on the data store 215, the client may provide a universal resource identifier (URI) to the server 210. The URI may be formatted, as described in more detail below, to identify data that exists in the data store 215. In one embodiment, the URI may be sent using HTTP.

In response to a URI that indicates a request to read data, the server 210 may obtain data from the data store 215, format it appropriately for use by the client 205, and send the formatted data back to the client. The server may employ a Web server 225 to communicate with the client 205 according to the HTTP protocol.

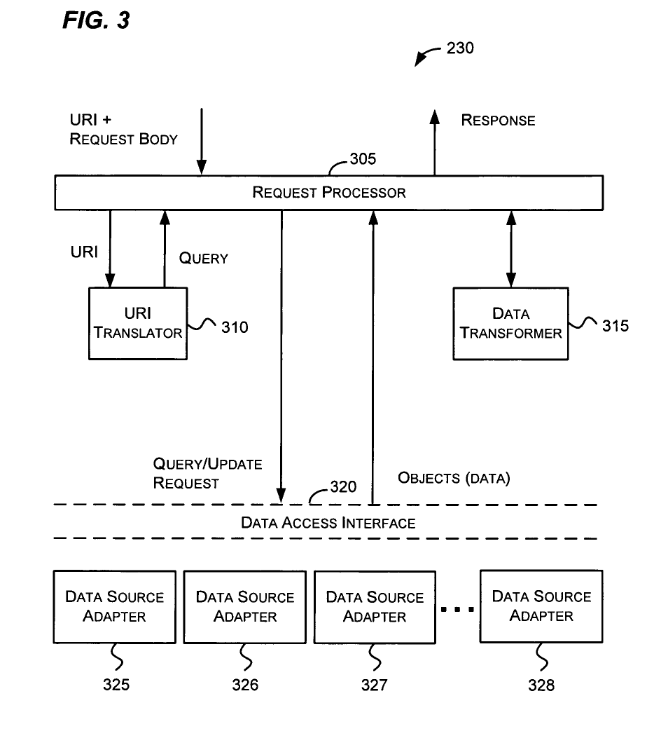

The Web server 225 may employ data accessing components 230 to use the information provided by the client 205 (e.g., a URI) to access data on the data store 215. The data accessing components 230 are described in more detail in conjunction with FIG. 3.

The data on the data store 215 may be formatted in almost any conceivable format. More structured formats may include those found in a database management system (DBMS) while less structured formats may include those found in one or more flat files, documents, or other data storage formats. The data accessing components 230 are structured such that they are able to find data in the appropriate format on the data store 215.

FIG. 3 is a block diagram illustrating the data accessing components of FIG. 2 in accordance with aspects of the subject matter described herein. The components illustrated in FIG. 3 are exemplary and are not meant to be all-inclusive of components that may be needed or included. In other embodiments, the components or functions described in conjunction with FIG. 3 may be included in other components or placed in subcomponents without departing from the spirit or scope of aspects of the subject matter described herein.

Turning to FIG. 3, the data accessing components may include a request processor 305, a URI translator 310, a data transformer 315, a data access interface 320, and data source adapters 325-328. Data access may be divided into two cases: data retrieval and data update.

For data retrieval, a request may include a URI plus information (e.g., options indicated in headers) that indicates the content types that are supported by a client. The request processor 305 receives the request and determines whether the request is a data retrieval request or a data update request. The request processor 305 may make its determination based on the “verb” used in the HTTP.

HTTP includes a method called “GET” that indicates that a resource is to be retrieved. HTTP also includes methods called “PUT,” “POST,” “DELETE,” and so forth. These are sometimes called HTTP “verbs.” When the request processor 305 receives the verb GET, it may determine that the request is a data retrieval request. When the request processor 305 receives the verbs POST, PUT, DELETE, similar verb, or the like the request processor may determine that the request is a request to update data (where update may include deleting the data).

In response, the request processor 305 may first pass the URI to the URI translator 310. The URI translator 310 may parse the URI and produce a data structure (e.g., a query tree) that represents a data query corresponding to the URI. This data structure is passed back to the request processor 305 which then passes the data structure to the appropriate data source adapter via the data access interface 320. In one embodiment, the appropriate data source adapter may be determined via information included in the URI as described in more detail below.

Each data source adapter is associated with a particular data source. A data source adapter includes logic for accessing data on its associated data source. For sophisticated data sources (e.g., such as a DBMS), a data source adapter may translate the data structure into a query suitable for the data source and send the query to the data source. For less sophisticated data sources (e.g., data in a flat file), the data source adapter may use the data structure and the data source adapter's knowledge of the structure of data in a data source to find the appropriate data in the data source.

In other embodiments, where the data source adapter interacts with a data source, the data source adapter may communicate with yet another component that is capable of accessing data in the data source. This other component may have an interface that allows the data source adapter to present a request for data and to receive the response to such a request.

In conjunction with receiving (or retrieving) the data from its associated data source, a data source adapter may transform this data into one or more objects that may then be sent back to the request processor 305. The request processor 305 may present these one or more objects to the data transformer 315 which may then transform the objects into a form that is understood by the client that requested the data. This may then be passed back to the request processor 305 which may then send a response to the client.

A data update request is similar to a data retrieval request. The data update request includes a URI which indicates the data to be modified or deleted. If the data update request is a request to add new data, the URI may indicate where the new data is to be added. For example, the URI may identify a container in which the new data is to be added. The request body may include the data that is to be modified or created. The request processor 305 may pass the request body through the data transformer 315 to obtain data suitable for passing through the data access interface 320.

The selected data source adapter performs the operation on its associated data source and uses the data obtained from the data transformer 315 if appropriate (e.g., when processing a create or modify request).

Some data sources return an updated version of the data that was changed. The changes to the data may be different from those requested as data source mechanisms may enforce constraints or trigger additional actions when updates occur to data. The updated data may be sent back to the data source adapter which may packet the data into objects and send it to the request processor 305. The request processor 305 may provide the updated data to the data transformer 315 which may transform the data into a form suitable for the client. The request processor 305 may then send the transformed updated data to the client that requested the changes.

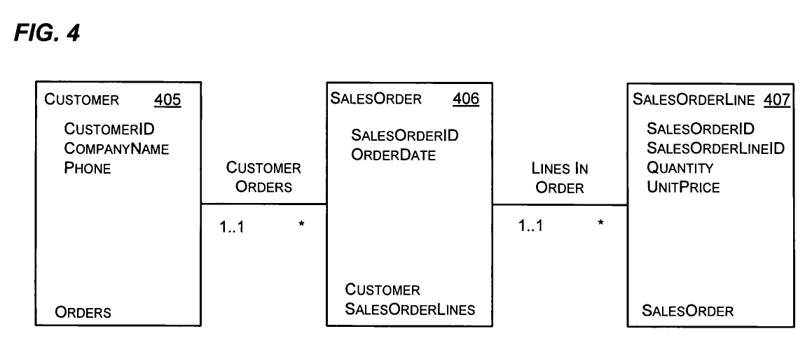

FIG. 4 is a block diagram that generally represents exemplary entity types and associations that may be stored in a data source in accordance with aspects of the subject matter described herein. The entities and associations illustrated in FIG. 4 are intended to be exemplary only and are not intended to limit aspects of the subject matter described herein. Indeed, based on the teachings herein, those of skill in the art will recognize many different arrangements of entities and associations thereof that may be supported by aspects of the subject matter described herein.

The exemplary entity types illustrated in FIG. 4 include a Customer entity type 405, a SalesOrder entity type 406, and a SalesOrderLine type 407. A Customer entity may be associated with zero or more SalesOrder entities. A SalesOrder entity may be associated with zero or more SalesOrderLine entities.

The Customer entity type 405 indicates that a Customer entity includes a CustomerID, a CompanyName, and a Phone. The Orders property may define how to navigate to zero or more SalesOrder entities that are associated with a Customer entity defined according to the Customer entity type 405.

The SalesOrder entity type 406 indicates that a SalesOrder entity includes a SalesOrderID and an OrderDate. The Customer property defines how to navigate to a Customer entity that is associated with a SalesOrder entity. The SalesOrderLines property defines how to navigate to zero or more SalesOrderLines entities that are associated with a SalesOrder.

The SalesOrderLine entity type 407 indicates that a SalesOrderLine entity includes a SalesOrderID, a SalesOrderLineID, a Quantity, and a UnitPrice. The SalesOrder property defines how to navigate to a SalesOrder entity associated with a SalesOrderLine entity.

Herein, sometimes an entity that is defined by an entity type may be referred to as an instance. Instances of entity types may reside in an entity set. Instances of associations between entities may reside in an association set. An entity container may include a set of one or more entity sets and/or one or more association sets.

As used herein, the term “resource” may comprise one or more entities. A URI may be defined with the following components:

<scheme>://<base_service>/<path>?<options>

For HTTP implementations, the component scheme is either “http” or “https.” The base_service identifies a particular service that provides access to resources. The service may execute on a Web server (e.g., the Web Server 225 or FIG. 2), to provide resources to clients. An exemplary URI that identifies a particular service is:

http://domain.com/data.svc

The path component indicates the resource to access. There are two basic operators that are used to build this component of the URI: a member access operator and a key-based access operator. A member access operator is used when the prefix URI points to a specific (singleton) entity, whereas a key-based access operator is used when the prefix URI points to a set of entities.

Member access may be performed by using the name of the member as part of the path. For example, if the /data.svc service has a Customer member (referring to the Customers entity-set), the URI below points to the set of all Customer entity instances contained in that entity-set:

/data.svc/Customers

Key-based access is used to point to a specific resource within a set. In cases where the entity key is made of more than one attribute, key-based access may comprise, for example, a comma-separated list of name/value pairs for a resource. This list may be enclosed in parenthesis. Continuing with the example above, if there is a Customer instance with a key 123 in the Customers entity-set the URI to point to that Customer instance is:

/data.svc/Customers(123)

Member and key-based access operators may occur several times within the path component to continue to drill down into the namespace of resources. Using the example schema where a Customer has an association to SalesOrder entities pointed at by the Orders navigation property, the URI below represents all of the sales orders for a particular customer:

/data.svc/Customers(123)/Orders

Since the above URI yields a set, a key-based access operator could be applied to access a particular sales order, further drilling into the resource namespace.

Member access and key-based access are not required to be interleaved 1:1. In the case where a member access operator results in a singleton entity being returned, then only further member-access operations may be applied. For example, if the Customer entity type had a ResponsibleEmployee navigation property, access to the name of the employee could be done through the URI:

/data.svc/Customers(123)/ResponsibleEmployee/Name

The last component of the URI, options, represents a set of predefined operations that may be applied to the resource pointed at by the URI. The options component may be included in the query part of the URI. The table below includes some exemplary options:

| Keyword | Description | Example |
|---|---|---|
| top | Take the top-N entities from the set | $top = 10 |
| skip | Skip the first N entities from the set | $skip = 20 |
| orderby | Comma-separated list of fields | $orderby = State, |
| | to sort a set of entities | Country |
| filter | Filters a set of entities | $filter = City eq |
| | | ‘Seattle’ |
| expand | Expand a related entity or set of related | $expand = Orders |
| | entities inline | |

More than one option may be used in a URI. For example, to obtain the third page in pages of 10 customers in the city of Seattle the URI would be:

/data.svc/Customers?$filter=City eq ‘Seattle’&
$top=10&$skip=20

Top and skip accept integer values and are used to enable applications to “page” through results. This functionality may be used in a graphical user-interface that deals with data sets that do not fit in a single screen. Being able to request specific “pages” of entities from the server may increase the efficiency of the application as only the requested data travels across the network.

The orderby option is translated to a sort operation in the underlying data source. The orderby option allows for a comma-separated list of fields to be specified, along with an optional ascending/descending modifier to change the sort order.

The filter may be implemented using a small scalar expression language to express filter predicates. The language may include literal forms for numbers and strings (quoted using single-quote character), identifiers to refer to members of the entity being filtered, and a basic set of comparison, arithmetic, and boolean operators. In one embodiment, operators may be expressed using letters and not symbols (e.g. “eq” instead of “=”) to reduce the escaping used in URIs in order to make them formatted according to standards for URIs.

Finally, the expand option is a round-trip optimization feature that allows clients to request a given entity and other related entities in a single operation. For example, if an application displays SalesOrder entities and always includes the order details, it can use the expand option to avoid having to do an additional round-trip to the server to retrieve the order lines. The option works both on URIs that point to sets and those that point to a specific entity, e.g.:

1. URI that points to a set:

/data.svc/SalesOrders(123)?$expand=SalesOrderLines;

2. URI that points to a specific entity:

/data.svc/SalesOrders?$filter=OrderDate lt ‘2007-1-
1’&$expand=SalesOrderLines

The option expand may be used with several properties by indicating their names separated by comma, and may also go multiple levels deep by specifying the path using path-notation. For example SalesOrderLines/Product means to expand SalesOrderLines and within them continue expanding the Product association.

Some examples of translations between exemplary URIs and resources have been described above. The table below illustrates some translations that a URI translator (e.g., the URI translator 310 of FIG. 3) may perform to translate a URI into a data structure for use in finding a resource on a data source.

| Component of the URI | Translation |
|---|---|
| First identifier, an entity-set name | Scan_{entity-set} |
| Member-access, where member is a regular | Project_{property} (input) |
| property | |
| Member-access, where member is an | Project_{property} (input) |
| association of cardinality 0 or 1 | |
| Member-access, where member is an | CrossApply (input, |
| association of cardinality >1 (“*”) | Project_{property} (input)) |
| Key-based access | Filter_{key-field=value} (input) |

Note that the term “CrossApply” in the table above refers to a join where the right-side input is a set of rows that result from a function of each element from the left-side input. In Language Integrated Query (LINQ) terminology, the CrossApply corresponds to a SelectMany operator.

The following table illustrates a translation between elements of a URI and LINQ operations:

| Component of the URI | Translation |
|---|---|
| First identifier, an entity-set name | Scan_{entity-set} |
| Member-access, where member is a regular | Project_{property} (input) |
| property | |
| Member-access, where member is an | Project_{property} (input) |
| association of cardinality 0 or 1 | |
| Member-access, where member is an | CrossApply (input, |
| association of cardinality >1 (“*”) | Project_{property} (input)) |
| Key-based access | Filter_{key-field=value} (input) |

Note that a query data structure may be created by composing queries. For example, the resource identified by the URI, /data.svc/Customers(123)/Orders(5) may be created by composing several query operators as follows:

Q₀=S_{c}, where S_{c} means return all the entities in the Customer table.

Q₁=Q₀.Where(c.ID==123). This returns the Customer entity with the ID of 123.

Q₂=Q₁.SelectMany(c.Orders). This returns an entity set that includes the Orders that are associated with the Customer entity with the ID of 123.

Q₃=Q₂.Where(o.ID==5). This returns the Order entity with the ID of 5.

To translate a URI to LINQ operations, the following table may be used:

| Component of the URI | LINQ Translation |
|---|---|
| Orderby | OrderBy[Descending] |
| | ThenBy[Descending] |
| | Note that ascending order may be the default. |
| | To obtain descending order additional |
| | information may be submitted in the URI. |
| Filter | Where |
| Top | Take |
| Skip | Skip |
| Key-based access | Where(key) |
| Member access operator | If the cardinality is <=1: Select(member) |
| | If the cardinality is >1: SelectMany(member) |

The cardinality being less than or equal to one indicates that the property is either a simple property or a link to another single entity. If the cardinality is greater than one, this indicates that the property is a link to an entity set that includes more than one entity.

In one embodiment, the translation may take place by first translating the URI into a data structure (e.g., a query tree) and then translating the data structure into LINQ operations.

The examples provided previously regarding URIs and their corresponding translations may be represented in the C# language as illustrated in the following table:

```
(i) /data.svc/Customers
  -> src.Customers
(ii) /data.svc/Customers(123)
  -> src.Customers
      .Where(c => c.id == 123)
(iii)  /data.svc/Customers(123)/Orders
  -> src.Customers
      .Where(c => c.id ==123)
      .SelectMany(c => c.Orders)
(iv) /data.svc/Customers(123)/ResponsibleEmployee/Name
  -> src.Customers
      .Where(c => c.id == 123)
      .Select(c => c.ResponsibleEmployee)
      .Select(e => e.Name)
(v) /data.svc/Customers?$filter=City eq
  ‘Seattle’&$top=10&$skip=20
  -> src.Customers
      .Where(c => c.City == “Seattle”)
      .OrderBy(c => c.id)
      .Skip(20)
      .Take(10)
```

As mentioned previously, the HTTP protocol includes verbs. These verbs may be mapped to various data access operations. The GET verb may be used to retrieve a single resource. The resource may be atomic or composite, containing other independently-addressable sub-resources (“the sales orders for the customer with key 123”, written /Customers(123)/Orders, is an example of such a composite resource).

The POST verb may be used to create a resource. A POST request includes a URI of the container where the resource is to be created. The URI may be translated to a query data structure (e.g., by the URI translator 310 of FIG. 3) to be used by a data source adapter to determine the container (e.g., entity set) in which the resource is to be created. A single POST may create one or more resources including resources that are linked to by a resource.

The system may respond to a POST request with a response that indicates whether the creation was successful. The response may also include the final version of the entity as stored in the underlying data source. The final version may contain additional data (e.g. an automatically-generated identifier) as well as updated data (e.g. if the store is a DBMS, it could have a trigger that updates some of the columns). The inclusion of the response may be turned on/off using a request header for bandwidth saving purposes if the returned information is not desired. Below is an exemplary POST command for creating a new company:

```
POST /data.svc/Customers HTTP/1.1
Host: ...
Content-Type: application/json
{
  ”CompanyName”: ″New Company″,
  ”Phone”: ″111-222-3344″
}
```

Note that the client may specify a content type that indicates the format of data included in the create request. Also, note that the above POST command is intended to be exemplary only and is not intended to limit the spirit or scope of aspects of the subject matter described herein. Any POST command data structure that identifies the container in which the resource will be created and that includes the values to use in creating the resource may be used without departing from the spirit or scope of aspects of the subject matter described herein.

A POST command may associate a specific entity with a created entity. Below is a sample POST command that creates a SalesOrder entity and associates the SalesOrder entity with a specific Customer entity:

```
POST /data.svc/SalesOrders HTTP/1.1
Host: ...
Content-Type: application/json
{
  OrderDate: “\/Date(1086048000000)\/”,
  Customer: {
    _metadata: { uri: “/Customers(123)” }
  }
}
```

Again, note that the above POST command is intended to be exemplary only and is not intended to limit the spirit or scope of aspects of the subject matter described herein. Indeed, with the teachings herein, those skilled in the art will recognized many different POST command data structures that may be utilized to create a resource and link the resource to another resource. Such other structures are also to be included in the scope and spirit of aspects of the subject matter described herein.

The PUT verb may be used to change an existing resource. PUT requests include the URI of the resource being updated, with the request body containing values for the members to be updated. To update the Customer entity created with POST above, a client may submit the request below:

```
PUT /data.svc/Customers(123) HTTP/1.1
Host: ...
Content-Type: application/json
{
  ”CustomerID”: ”123”,
  ”CompanyName”: ″New Company (updated)″,
  ”Phone”: ″999-888-7766″
}
```

Note that the full URI needs to be known in this case, not only the container. The key for this customer is “123” in the example. Again, note that the form of the PUT data structure identified above is exemplary and is not intended to limit aspects of the subject matter described herein to the specific form identified above. Indeed, in light of the teachings herein, those skilled in the art will recognized many other forms of the PUT data structure that may be utilized without departing from the spirit or scope of aspects of the subject matter described herein.

Sending a DELETE request to a URI pointing to a specific entity causes the entity to be deleted from the underlying data source. If the underlying data source has constraints that would be violated if the entity was deleted then an error may occur.

In one embodiment, a DELETE request may point to a set of entities. In this embodiment, each of the entities in the set may be deleted provided that doing so does not violate some constraint or cause another error to occur.

A DELETE request does not include a body and may just include the URI of the entity to be deleted.

In some embodiments, there are certain resources that cannot be deleted. Specifically, entity sets both at the top level (e.g. /Customers) and from association traversals (e.g. /Customers(123)/SalesOrders) may not be deleted.

To define the exposed top level entities, the following exemplary syntax may be used:

```
public class Customer
{
    public int CustomerID { get; set; }
    public string CompanyName { get; set; }
    public ICollection<SalesOrder> Orders { get; }
    /* ... */
}
public class SalesOrder
{ /* ... */ }
public class SalesOrderLine
{ /* ... */ }
public class CustomerData
{
  public Interface<Customer> Customers
  { /* ... */ };
  public Interface<SalesOrder> SalesOrders
  { /* ... */ };
  public Interface<SalesOrderLine> SalesOrderLines
  { /* ... */ };
}
```

The above example is not intended to limit the spirit or scope of aspects of the subject matter described herein to the exact form described above. Indeed, in light of the teachings herein, those skilled in the art will recognized many alternative forms that may also be used without departing from the spirit or scope of aspects of the subject matter described herein.

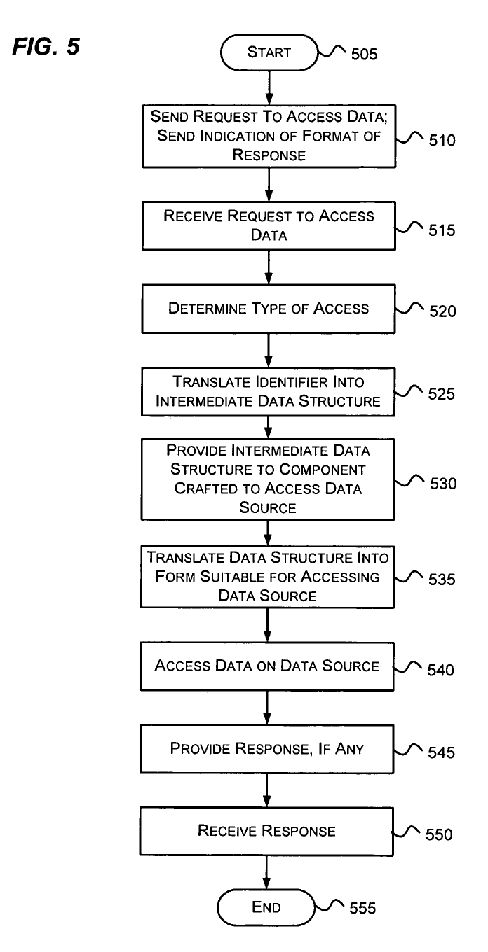

FIG. 5 is a flow diagram that generally represents exemplary actions that may occur in accordance with aspects of the subject matter described herein. For simplicity of explanation, the methodology described in conjunction with FIG. 5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 5, at block 505, the actions begin. At block 510, a request to access data is sent. In conjunction with sending the request an indication of the format of the response may also be sent. For example, referring to FIG. 2, the client 205 may send a URI to the Web server 225 requesting access to a resource on the data store 215.

At block 515, the request to access data is received. For example, referring to FIG. 2, the Web server 225 may receive the request sent by the client 205.

At block 520, a determination is made as to the type of access requested. For example, referring to FIG. 3, the request processor 305 may determine that the request is a request to delete a resource indicated by the URI passed in the request.

At block 525, the identifier is translated into an intermediate data structure. For example, referring to FIG. 3, the URI translator 310 may translate the URI into an intermediate data structure that represents query operations that define the requested data. These query operations may be constructed by composing multiple query operators as described previously.

In one embodiment, to translate (e.g., create) the intermediate data structure, the URI translator 310 parses the path included in the identifier to find a first component (e.g., “Customers”) of a path. This first component (which is not necessarily at the beginning of the path) may identify a first entity set. In conjunction with finding the first component, the URI translator 310 may parse the path to find a second component of the path (e.g., “123”). This second component of the path may identify a key to use in selecting a particular entity from the entity set. Also in conjunction with finding the first component, the URI translator 310 may parse the path to find a third component of the part (e.g., “Orders”). This third component may be used to identify a second entity set that is linked to the first entity set.

In another embodiment, to translate (e.g., create) the intermediate data structure, the URI translator 310 may parse the path to find a component of the path (e.g., “Customers”) and determine whether the component of the path identifies a specific entity (e.g., a specific customer) or a set of entities (e.g., a set of customers). If the component identifies a specific entity, the URI translator 310 may place a key-based access operator in the intermediate data structure. This key-based access operator indicates, in part, that the specific entity is to be operated on by subsequent operations included in the intermediate data structure, if any.

If the component identifies a set of entities, the URI translator 310 may place a member access operator that indicates, in part, a set of entities to be operated on by subsequent operations (if any) included in the intermediate data structure.

At block 530, the data structure is provided to a component crafted to access the data source upon which the data resides. The component may be one of several components, each of which are operable to translate information in the data structure into one or more data access operations suitable for accessing the data in a data store associated therewith. For example, referring to FIG. 3, the request processor 305 provides the data structure to one of the data source adapters 325-328 via the data access interface 320.

At block 535, the data structure is translated into a form suitable for accessing the data source. As described previously, the data structure may not be in the same language or format that the data source adapter uses to access the data on the data source. Instead, the data source adapter may use the data structure to determine actions to perform or another query formatted in accordance with another query language to submit to a DBMS to obtain the requested data.

At block 545, the data is accessed on the data source. For example, referring to FIG. 2, the data accessing components 230 access the data on the data store 215.

At block 545, a response may be provided. For example, referring to FIG. 3, the request processor 305 may provide a response to the requester if a response is expected, for example.

At block 550, the response, if provided, is received. For example, referring to FIG. 2, the client 205 receives a response that the data has been accessed.

At block 555, the actions end.

As can be seen from the foregoing detailed description, aspects have been described related to translating an identifier in a request into a data structure. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving a request to access data, the request including an identifier associated with the data, the identifier indicating information including a service to use to access the data and a path to the data, the path indicating one or more of: one or more entities of a first entity set, a key to identify a particular entity in the entity set, and a link identifying a second entity set associated with the first entity set;
creating an intermediate data structure based at least in part on the identifier, the intermediate data structure representing query operations that define the data; and
providing the intermediate data structure to one of a plurality of components, each of the components operable to translate information in the data structure into one or more data access operations suitable for accessing the data in a data store associated with the component.

2. The method of claim 1, wherein creating the intermediate data structure comprises:
parsing the path to find a first component of the path, the first component of the path identifying the first entity set;
parsing the path to find a second component of the path, the second portion of the path identifying the key; and
parsing the path to find a third component of the path, the third component of the path identifying the second entity set.

3. The method of claim 1, wherein creating the intermediate data structure comprises:
parsing the path to find a component of the path;
determining whether the component of the path identifies a specific entity or a set of entities;
if the component of the path identifies a specific entity, placing a key-based access operator in the intermediate data structure, the key-based access operator indicating, at least in part, that the specific entity is to be operated on by subsequent operations included in the intermediate data structure, if any; and
if the component of the path identifies set of entities, placing a member access operator in the data structure, the member access operator indicating, at least in part, that a set of entities indicated by the member access operator is to be operated on by subsequent operations included in the intermediate data structure, if any.

4. The method of claim 1, wherein the request is formatted according to a Hypertext Transfer Protocol and the identifier comprises a Uniform Resource Identifier formatted according to the Hypertext Transfer Protocol.

5. The method of claim 1, wherein the request to access data comprises a request to retrieve, update, create, or delete the data.

6. The method of claim 1, further comprising translating the intermediate data structure into a form suitable for accessing the data from the data source.

7. The method of claim 6, wherein translating the intermediate data structure into a form suitable for accessing the data from the data source comprises translating the intermediate data structure into a query language associated with the data source.

8. The method of claim 7, wherein the query language comprises a language used to access data in a relational database.

9. The method of claim 6, wherein the form comprises a set of actions for accessing the data from the data source.

10. The method of claim 1, wherein each of the entities comprises a set of one or more properties, each property including data of the entity or indicating one or more entities associated with the entity.

11. In a computing environment, an apparatus, comprising:
a request processor operable to receive a request for access to at least one resource and to return a response the request, the request including an identifier associated with the at least one resource;
an identifier translator operable to parse the request to create a data structure that represents a data query corresponding to the identifier, the identifier translator further operable to translate components of the identifier that correspond to single entities into key-based access operators and components of the identifier that correspond to sets of entities into member access operators;
a data access interface operable to receive the request and to present the data structure to a data source adapter; and
a data source adapter operable to use the data structure to access the at least one resource.

12. The apparatus of claim 11, wherein the request is formatted according to a Hyptertext Transport Protocol that includes verbs including GET, POST, PUT, and DELETE.

13. The apparatus of claim 12, wherein the request processor determines whether the request is a request to update the data or to retrieve the data based on a Hypertext Transport Protocol verb included in the request.

14. The apparatus of claim 11, wherein the request includes an indication of a format in which the response is to be formatted.

15. The apparatus of claim 14, wherein the apparatus further comprises a data transformer operable to receive data from the request processor and to format the data according to the format indicated in the request.

16. The apparatus of claim 11, further comprising another data source adapter, the other data source adapter crafted to communicate with another data source using operations that are different than operations used by the data source adapter, the other data source adapter operable to use the data structure in accessing data on the other data source, the other data source adapter operable to receive the data structure via the data access interface.

17. A computer storage medium having computer-executable instructions, which when executed perform actions, comprising:
sending a request to access data to a Web server, the request including an identifier, the identifier indicating information including a service to use to access the data and a path to the data, the path indicating one or more of a first entity set, a key to identify a particular entity in the entity set, and a link identifying a second entity set associated with the first entity set, the path including components that correspond to a member operators and key-based operators;
sending an indication of a format in which a response to the request is to be; and
receiving a response formatted according to the format.

18. The computer storage medium of claim 17, wherein the request is formatted in a different form than a query language used to access the data from the data source.

19. The computer storage medium of claim 17, wherein the request is formatted according to a Hyptertext Transport Protocol suitable for identifying resources.

20. The computer storage medium of claim 17, wherein the request to access data comprises a request to update existing data, add new data, or delete existing data.
